(19) United States
(12) Patent Application Publication
(10) Pub. No.: US 2026/0034630 A1
(43) Pub. Date: Feb. 5, 2026

(54) METHOD, APPARATUS AND PROCESSING CENTER FOR AUTONOMOUSLY MEASURING A TOOL OR A COMPLETE TOOL

(71) Applicant: Franz Haimer Maschinenbau KG, Hollenbach-Igenhausen (DE)

(72) Inventors: Olaf Stoffels, Verl (DE); Kai Duhme, Bielefeld (DE)

(21) Appl. No.: 19/288,058

(22) Filed: Aug. 1, 2025

(30) Foreign Application Priority Data
Aug. 1, 2024 (DE) 10 2024 122 026.0

(51) Int. Cl. B23Q 17/09; G06T 7/00

(52) U.S. Cl. CPC B23Q 17/0914; G06T 7/001; G06T 2207/30164

(57) ABSTRACT

A method, an apparatus and a processing center for autonomously measuring a tool or a complete tool, include a tool holder and a tool clamped in the tool holder. The autonomous measurement involves a type of the tool first being autonomously determined, a point on the tool that distinguishes the tool then being autonomously determined according to the type of the tool, functional geometries of the tool being autonomously measured starting from this point, and subsequently a cumulative geometry being autonomously ascertained for the tool from the measured functional geometries.

### CROSS-REFERENCE TO RELATED APPLICATION

This application claims the priority, under 35 U.S.C. § 119, of German Patent Application DE 10 2024 122 026.0, filed Aug. 1, 2024; the prior application is herewith incorporated by reference in its entirety.

### FIELD AND BACKGROUND OF THE INVENTION

The invention relates to a method, an apparatus and a processing center for autonomously measuring a tool or a complete tool including a tool holder and a tool clamped in the tool holder.

It is customary to measure a complete tool including a tool holder and a tool that is clamped, for example shrink-fitted, in the tool holder, for example a shrink-wrapped milling or clamped cutting tool, before it is coupled to a machine tool, for example in the form of a CNC processing machine, by using an apparatus for measuring a tool, also called a “presetting instrument” for short (“presetting”).

The (geometric) dimensions of the tool, or complete tool, determined by using the presetting instrument are then made available to, or used in, the machine tool to optimize workpiece processing in the machine tool.

The presetting ensures in particular that parts of the tool that process a workpiece, for example a cutting edge of a cutting/milling tool, have the position dimensions acceptable for the planned processing of the workpiece on the machine tool. Put simply and in general terms, tools are checked and inspected to ensure that all the relevant dimensions and features are dimensionally accurate.

Such a presetting instrument is used to measure in particular the length of the complete tool, the diameter and/or the blade shape of the clamped tool, or cutting/milling tool—and possibly various other dimensions of, or for, the tool, or complete tool.

If those data are directly relevant to the quality of the workpiece processing of the workpiece in the machine tool, the tool measurement in the presetting instrument needs to be carried out with great (repetition) accuracy.

Such a measuring device, or such a presetting instrument, is known for example from the presetting instrument of the “UNO” series or the “VIO” series from the company Haimer GmbH of Igenhausen, Germany.

That known measurement of complete tools, for example by using the known presetting instruments, is usually automated or automatic in order to provide a process that is as error-free and safe and also efficient and effective as possible—for example within the scope of automatic industrial production processes.

However, automatic, at that point, means that although important sub-sequences/sub-processes during tool measurement (can) take place without the agency of an operator, for example certain measurement processes, a totally operator-independent process, i.e. an autonomous process, has not yet been implemented. That means that operator actions, for example input of tool data and/or identification information for the tool, or complete tool, through to the complete programming of a measurement sequence into a measurement controller, are also required for that automatic process, or for that automatic tool measurement, according to the prior art.

That is also attributable, among other things, to the fact that sub-process steps for known tool measurements are highly complex and possibly inadequately structured, requiring the aforementioned operator actions/inputs—and therefore the process as a whole proves not to be “autonomizable”. That means that a completely autonomous process cannot be provided in the prior art.

### SUMMARY OF THE INVENTION

It is accordingly an object of the invention to provide a method, an apparatus and a processing center for autonomously measuring a tool or a complete tool, which overcome the hereinafore-mentioned disadvantages of the heretofore-known methods, apparatuses and processing centers of this general type and which improve the measurement of tools, or complete tools, known in the prior art, in particular in such a way that it becomes, or is, feasible in a completely operator-independent, or operator-free, i.e. autonomous, manner.

With the foregoing and other objects in view there is provided, in accordance with the invention, a method, an apparatus and a processing center for autonomously measuring a tool or a complete tool, comprising a tool holder and a tool clamped in the tool holder, having the features of the respective independent claims described below.

Advantageous developments of the invention are the subject matter of dependent claims and of the description below and relate both to the apparatus according to the invention and to the method according to the invention.

Any terms that are used, such as above, below, front, rear, left or right-unless explicitly defined otherwise—should be understood in the usual way—including with regard to the present figures. Terms such as radial and axial, where used and not explicitly defined otherwise, should be understood in relation to central/longitudinal axes, or axes of symmetry, of component parts/components described here—including with regard to the present figures.

The expression “substantially”—where used—may (in accordance with the understanding of the Supreme Court) be understood to mean “to a practically still significant degree”. Possible deviations from exactness that are thus implied by this concept may arise unintentionally (that is to say without any functional basis) owing to manufacturing or assembly tolerances or the like.

“Autonomous”—in contrast to “automated”—means that-apart from for triggering a start signal—no operator intervention, or operator action, is necessary, or that an “autonomous process” of this kind—using corresponding apparatuses—can run completely independently (and without an operator).

For the sake of simplicity, use of the term “tool” hereinbelow should also cover the “complete tool” including a tool holder and a tool clamped in the tool holder.

The method for autonomously measuring a tool (for short) involves a type of the tool first being autonomously determined.

The determined type of the tool can be in particular a rotary tool and/or a machining tool, for example a milling tool, possibly with indexable inserts, a drilling tool, a turning tool, possibly with cutting inserts, or a grinding disc.

In particular, it is also expedient in this context if the type of the tool is determined by using Artificial Intelligence-based image processing.

A point on the tool that distinguishes the tool is then autonomously determined—according to the type of the tool.

It is expedient if the point—for example in the case of a drilling tool—is a topmost (or highest) point of the tool or if the point—for example in the case of a milling tool or a grinding disc—is a point on an outer edge of the tool.

Functional geometries of the tool are autonomously measured starting from this point.

A functional geometry of this kind can be, for example, a blade of a machining tool, such as a milling tool or drilling tool, or a grinding disc edge region in the case of a grinding disc.

It is expedient in particular if the tool is turned, or rotated, during measurement, in particular while clamped in a spindle, about its longitudinal axis, or central axis, the functional geometry (e.g. a blade) being autonomously recognized during turning, or rotation, and being measured.

This process including turning/rotation, recognition and measurement can be carried out repeatedly at least until the tool has completed a full revolution about its longitudinal axis, or central axis. Then, all functional geometries/blades on the tool have been recognized (max. number) and all functional geometries/blades have been measured.

Artificial Intelligence-based image processing can also be used for this recognition of the functional geometry/geometries.

It is furthermore also advantageous if the measured functional geometry/geometries of the tool is/are deposited and/or stored as a reference, with in particular a remeasurement of the tool involving the newly measured functional geometry/geometries being compared with the reference (for example by image comparison).

Here too, Artificial Intelligence-based image processing can be used.

This comparison—of the new functional geometry and the reference—can, in particular, detect, or ascertain, wear on a functional geometry and/or a defective functional geometry.

Subsequently, a cumulative geometry is autonomously ascertained for the tool from the measured functional geometries.

Here, it is in particular expedient if the cumulative geometry—for example represented by way of a cumulative image—is ascertained from a superimposition of the measured functional geometries of a tool, the cumulative geometry being in particular a profile of a maximum outer contour (in particular radially and axially) for the tool, or complete tool.

Furthermore, it can be advantageous if—using the cumulative geometry of the tool—in particular together with a minimum contour of the tool, a concentricity and/or a planarity and/or a roundness is ascertained for the tool.

A minimum contour of this kind can mean, for example—in comparison with the contour of the cumulative geometry—radially further inward (i.e. closer to the central, or longitudinal, axis of the tool) (measured) contours, or functional geometries, such as in particular radially further inward blades or grinding disc edge regions.

It is also expedient to store the cumulative image and/or the cumulative geometry and/or the minimum contour of a tool as a reference, with, here too, in particular a remeasurement of the tool then allowing the then accordingly newly determined cumulative images and/or cumulative geometries and/or minimum contours to be compared with their respective reference (for example by image comparison).

Here too, Artificial Intelligence-based image processing can be used.

This comparison then in particular also allows wear on the tool to be detected, or ascertained.

Furthermore, it is particularly advantageous if the tool is scanned, with in particular a 2D scan and/or a 3D scan being carried out—and a corresponding digital image representation of the tool being generated.

As such, it is thereby possible to ascertain a digital twin—as described in German Application DE 10 2017 117 840 A1, corresponding to U.S. Pat. No. 11,612,973 B1, the content of which is also hereby incorporated by reference in the subject matter of the application—and/or a collision-relevant or machining-relevant digital twin—as described in German Application DE 10 2022 123 017 A1, corresponding to U.S. Publication No. 2024/0082976 A1, the content of which is also hereby incorporated by reference in the subject matter of the application—of the tool.

It is then also expedient if the measurement/measurements of the tool as well as the functional geometry/geometries thereof and the (collision-relevant/machining-relevant) digital twin are compared.

This comparison can be carried out in particular in relation to, or at, a tool height or complete tool height that is present or in relation to, or at, different tool heights or complete tool heights that are possibly present (2nd/3rd plane, etc.).

For this purpose, it is also expedient for the method to be carried out not just at/in a (first) axial height/plane on the tool. That is to say that the method can expediently also be carried out at other axial heights (z-axis) (e.g. second/third plane, etc.) on the tool, for example where the diameter of a tool changes (e.g. steps in the case of a “step drill”) and/or where other, or additional, functional geometries, for example (further) indexable/cutting inserts, are disposed on a tool, and/or at another (any other) (axial) height that is possibly present.

Here, a/the measuring unit can then be moved autonomously in the z-axis direction/vertically—for example along an outer edge of the tool—as far as a (further) plane, where further functional geometries are recognized—by it—and where the measurement procedure described is repeated.

Furthermore, it can be expedient if measured surface points on the tool are connected—in particular using Artificial Intelligence-based image processing—to form a contour of the tool, or complete tool.

According to a preferred embodiment, there is provision for the method to be carried out using, or at/on, a rotary tool and/or a machining tool, such as a milling tool, a drilling tool or a grinding disc.

Furthermore—according to a particularly preferred development—the method can have one or more of the following steps, preferably in the stated order:

As such, it is possible to determine a highest point of the tool (cf. the point that distinguishes the tool) on a central axis (longitudinal axis) of the tool (z-axis). This means that the central axis (longitudinal axis) of the tool (z-axis) is traversed; the topmost, or highest, point of the tool on the axis is then determined.

It is (then) possible, in particular using the highest point, to check whether a tip is present on the tool. For example, AI (Artificial Intelligence), or image processing based on AI (Artificial Intelligence), can also be used for this purpose.

This can also be performed for example in such a way that neighboring points on the tool with respect to the highest point are sought/measured. If the points lie—axially (in the central axis/longitudinal axis, or z-axis, direction)—below the highest point, a tip can be assumed (at the highest point).

In the case of a tip—a drilling tool can (then) be determined as the type of the tool.

In the case of no tip—a radially outer edge on the tool (cf. the point that distinguishes the tool) can (then) be determined and blades (cf. functional geometry) on the tool can (then) be determined, in particular using the radially outer edge. This can be done in particular using predefined comparison patterns (possibly using AI).

The blades can then be measured.

If blades are found (and possibly measured), the tool can then also be assumed to be a milling tool. If such blades are also absent, a grinding disc could also be assumed—for the tool—and its circumferential grinding disc edge (cf. functional geometry) can be measured.

It is also particularly advantageous in particular if the method is carried out, or if the tool is processed in accordance with the method, using the apparatus for autonomously measuring a tool or a complete tool.

The apparatus for autonomously measuring a tool or a complete tool including a tool holder and a tool clamped in the tool holder provides a measuring unit and a computing and control unit.

The measuring unit and/or the computing and control unit are configured in such a way that a type of the tool can first be autonomously determined, a point on the tool that distinguishes the tool can then be autonomously determined according to the type of the tool, functional geometries of the tool can be autonomously measured starting from this point, and subsequently a cumulative geometry can be autonomously ascertained for the tool from the measured functional geometries.

It is expedient in particular if the measuring unit and/or the computing and control unit is configured to carry out the method or method steps according to the invention.

In this case, a “ . . . unit”, such as the measuring unit and the computing and control unit, can in particular also include a processor, a storage unit, an interface and/or an operating, control and calculation program, in particular stored in the storage unit.

Optionally, the measuring unit and/or the apparatus can include a control unit that provides for corresponding control of the measuring unit for carrying out one of the above-described methods according to the invention or method steps according to the invention.

According to one configuration, there can be provision for the measuring unit to have one or more optical and/or non-contact-measurement measuring apparatuses, for example a digital camera and/or a radar and/or a lidar and/or a measuring apparatus operating according to a transmitted or reflected light method, in particular with a (digital) image sensor. There can alternatively also be provision for different kinds of measuring apparatuses, for example a laser curtain—or other tactile or optical measuring systems.

Furthermore, it can be expedient here if—in the case of multiple measuring apparatuses—the tool or the complete tool, or the functional geometry thereof, is measured from different perspectives (axes), in particular in the case of turning tools, thereby allowing in particular positions of functional geometries, for example blades of cutting inserts, to be determined.

It is also advantageous if the type of the measuring apparatus is selected according to a requirement in respect of a measurement accuracy.

A processing center provides the apparatus and also a machine tool.

It is expedient here in particular if the apparatus and the machine tool are mounted on a common base and/or if the apparatus is integrated in the machine tool (functionally and/or for the component).

The invention is based on the insight that autonomous measurement of a tool becomes, or is, realizable only if—firstly—each process/method step by itself is automatable and all process/method steps are able to be carried out jointly in an integrated work environment, for example in a single apparatus, such as a presetting instrument, and—secondly—each piece of information necessary for the respective process/method step is already available at the beginning of each process/method step.

Proceeding therefrom, the invention generates a specific, surprisingly simple method regime according to the invention, or inventive method regime, with a specifically sorted sequence of automatable, or automated, process/method steps, which method regime fulfils or ensures the prerequisites above.

Thus, in the case of the method regime according to the invention, or inventive method regime, operator actions can be dispensed with if they are not necessary here,—and the autonomous method for measuring a tool that results from the method regime according to the invention, or inventive method regime, becomes—as a whole—able to be carried out totally autonomously.

As a result, the invention can then provide a fault-free and safe and also highly efficient and highly effective process—for example in the context of automatic industrial manufacturing processes. The invention thus makes a valuable contribution to the intelligent networking of machines and sequences in industry/industrial manufacturing, i.e. to Industry 4.0.

Another aspect of the invention relates to an apparatus for autonomously measuring a tool or a complete tool, in particular the apparatus, which provides a reader for reading data of a data carrier disposed on a tool holder at a measuring device carrier of the apparatus.

The description of advantageous configurations of the invention given so far includes numerous features that are reproduced in the individual dependent claims, in some cases in combination as a plurality. However, these features can expediently also be considered individually and combined to form expedient further combinations—including between the arrangements/apparatuses and methods.

Even if in the description or in the patent claims some terms are each used in the singular or in combination with a numeral, the scope of the invention is not intended to be limited to the singular or the respective numeral for these terms. Furthermore, the words “a” and “an” should be understood not as numerals, but as indefinite articles.

The properties, features and advantages of the invention that are described above and the manner in which they are achieved will become clearer and more clearly understandable in conjunction with the description of the exemplary embodiments of the invention that follows, the exemplary embodiments being explained in greater detail in conjunction with the drawing(s)/figure(s) (identical component parts/components and functions have the same reference signs in the drawings/figures).

The exemplary embodiments are used to explain the invention and do not restrict the invention to combinations of features specified therein, not even in regard to functional features. Moreover, features suitable therefor in each exemplary embodiment can also explicitly be considered in isolation, removed from an exemplary embodiment, introduced into a different exemplary embodiment in order to supplement same and/or be combined with any of the claims.

Other features which are considered as characteristic for the invention are set forth in the appended claims.

Although the invention is illustrated and described herein as embodied in a method, an apparatus and a processing center for autonomously measuring a tool or a complete tool, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE FIGURES

FIG. 1 is a diagrammatic, perspective view of a presetting instrument through the use of which an autonomous measurement of a tool can be carried out, in accordance with one embodiment according to the invention;

FIG. 2 is a view of a control menu in the case of the presetting instrument according to FIG. 1, which illustrates an autonomous measurement of a tool, in accordance with one embodiment according to the invention;

FIG. 3 is a view of an excerpt from the control menu according to FIG. 2 in the case of the presetting instrument according to FIG. 1, which illustrates an autonomous measurement of a tool, in accordance with one embodiment according to the invention;

FIG. 4 is a cumulative, perspective image (with a cumulative geometry and a minimum contour) of a milling tool, which is generated during an autonomous measurement of a tool, in accordance with one embodiment according to the invention; and

FIG. 5 is a fragmentary, perspective view of a measuring device carrier in the case of a presetting instrument having an integrated reader, in accordance with one embodiment according to the invention.

### DETAILED DESCRIPTION OF THE INVENTION

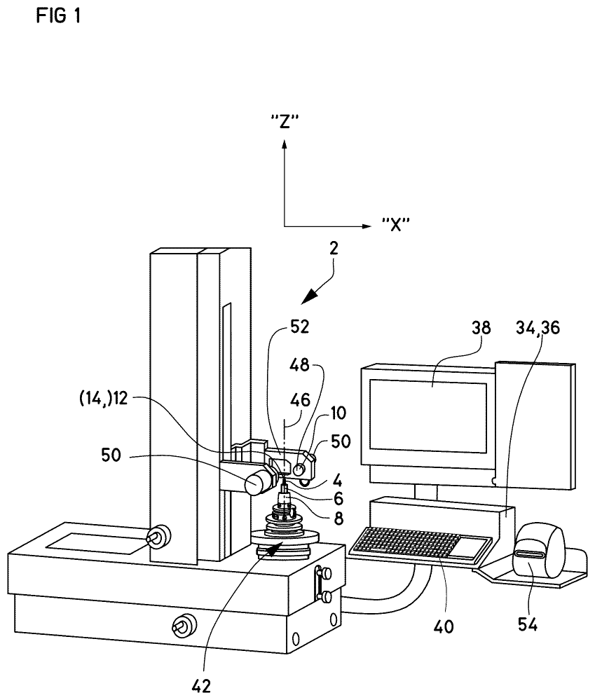

### Autonomous Measurement of a Tool (FIGS. 1 to 4)

Referring now to the figures of the drawings in detail and first, particularly, to FIG. 1 thereof, there is seen, in detail, a tool presetting instrument 2, or presetting instrument 2 for short—for measuring a tool 4, or a complete tool 6 (tool holder 8 and tool 4).

The presetting instrument 2 has an optical measuring apparatus 10, in the form of a camera apparatus 10, that can be used to record information from the tool 4, or complete tool 6—put briefly and simply, the tool is measurable.

In addition, the presetting instrument 2 has a computing and control unit 34 including, inter alia, a processor, a storage unit (memory for short), an interface with the camera apparatus, an interface 36 with a machine tool, and calculation and operating programs that are stored in the storage unit, are executable by the computing and control unit 34 and are “operable” via a display device 38 and input device 40, such as the autonomous measurement of a tool 4 (“Maximum SE”) which is the focus of attention here—and furthermore also the generation of the data for a collision-relevant digital twin and a machining-relevant digital twin of a tool 4, or complete tool 6, as described in German Application DE 10 2022 123 017 A1, corresponding to U.S. Publication No. 2024/0082976 A1.

The computing and control unit 34 is—by using corresponding calculation and operating programs—moreover also intended to enable execution, or performance, of a customary measurement of a tool 4, or a complete tool 6—using the camera apparatus 10—, customary presetting data being generated by the tool 4, or the complete tool 6.

Furthermore, the computing and control unit 34—likewise by using corresponding calculation and operating programs and using the camera apparatus 10—makes it possible to generate data of the tool 4, or the complete tool 6, for a collision check, namely the collision-relevant digital twin and the machining-relevant digital twin.

The or all measurement, or presetting, data—including those from the autonomous measurement of a tool 4 (“Maximum SE”) (referred to jointly for short just as measurement, or presetting, data)—and/or data of the collision-relevant digital twin and of the machining-relevant digital twin, for short the collision-relevant and the machining-relevant digital twin, can be provided—in the form of one or more data sets—in digital form for further machine processing, for example in the data formats VDA-FS, IFC, IGES, STEP, STL and DXF.

In the present case, separate data sets of measurement data, presetting data and the digital twins, and also a common data set of the digital twins, are provided.

The interface 36 with the machine tool (not shown) can be used to transfer/communicate the data, or the data sets, to the machine tool (where inter alia the simulated collision check can be carried out, or is carried out, by using the data).

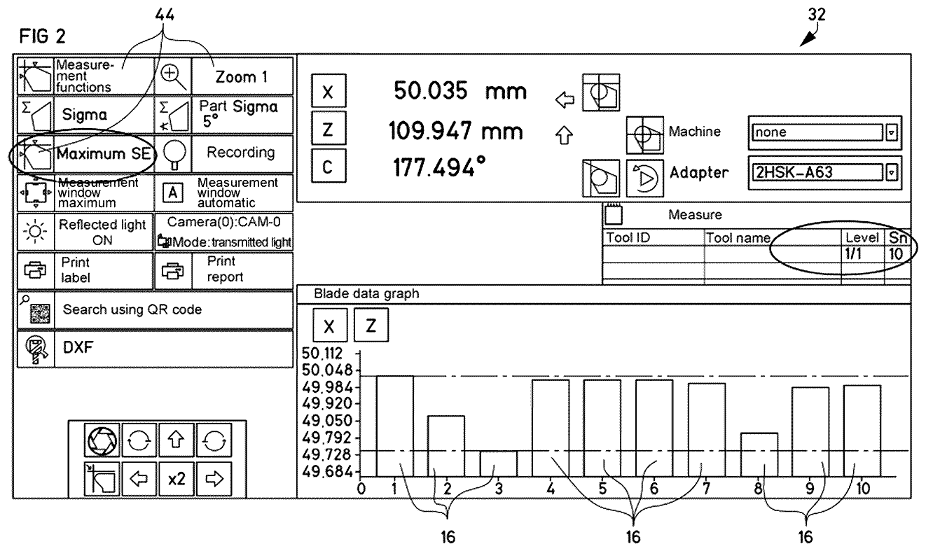

The presetting instrument 2 furthermore includes, as shown by FIG. 1 (cf. also FIGS. 2 to 4), the display device 38 in the form of a monitor 38 (with the functionality of a touchscreen) and the input device 40, which is in the form of a (separate) keyboard 40. Moreover, the input device 40 is also in the form of a touchscreen-functional monitor 38.

An operator can use the keyboard 40 and the touchscreen 38 to operate the calculation and operating programs, with functionalities, data and status displays of the calculation and operating programs being displayed (and thereby also becoming operable) on the monitor 38,—and initiate forwarding of the data, or the data sets, to the machine tool—via the interface 36.

As also shown by FIG. 1, the complete tool 6 is disposed on a spindle 42 that, in a manner controlled by using a corresponding function program—in particular also automatically by an actuator (not shown in more specific detail)—, is rotatable about a rotation/central, or longitudinal, axis 46 (z-axis).

The aforementioned camera apparatus 10 of the presetting instrument 2 is in the form of a transmitted-light system. In this case, a camera 48 and an illumination device 50 lie on opposite sides of a complete tool 6 disposed on the spindle 42. The camera apparatus 10 is mounted on a slide 52—and is displaceable along two axes (“x” and “z”) manually and in particular also automatically—in a manner controlled by using a corresponding function program.

An interface for a printer 54 is moreover available.

### Function Program “Autonomous Tool Measurement” (“Maximum SE”)

FIGS. 2 to 4 illustrate the sequence of the function program for autonomously measuring a tool, or complete tool.

FIG. 2 shows the control menu, or operating and display interface 32, such as is displayed on the display device 38/monitor/touchscreen 38 of the presetting instrument 2—and via which the autonomous measurement of a tool, or complete tool, is carried out, or started.

The illustration shows, on the left-hand side of the operating interface 32, various function programs of the presetting instrument 2—in the form of an disposed function button 44, and actually also the function program for autonomously measuring a tool, or complete tool, designated “Maximum SE” (cf. identification by border marker, FIG. 2).

Touching the function button 44 “Maximum SE” causes the autonomous measurement of a tool, or complete tool, to be started—which then proceeds thereafter totally without an operator, or autonomously. That is to say that any arbitrary tool that is not known at this time can be measured (and be created as a new tool in the tool management (as a data set))—without further operator assistance.

The camera apparatus 10 “searches” for the (arbitrary and “unknown”) tool 4 clamped/held in the spindle 42. That is to say that the camera apparatus 10 moves autonomously along the central axis 46 of the tool (z-axis) until it detects/recognizes (there) “first parts/regions” of the tool 4. In this case, it moves autonomously at the height of the highest point 12 of the tool 4 clamped/held in the spindle 42.

As such, it is thereby possible to determine a highest, or topmost, point 12 of the tool 4 on the central axis (longitudinal axis) 46 of the tool (z-axis).

The highest point 12 is then used to check whether a tip 14 is present on the tool 4. Measures for image processing based on AI (Artificial Intelligence) are used here for this purpose.

Alternatively, this could also be realized by searching for/measuring neighboring points with respect to the highest point 12 on the tool 4. If these points lie—axially (in the central axis/longitudinal axis, or z-axis, direction)—below the highest point 12, then a tip 14 can be assumed (at the highest point 12).

In the case of a tip 14—the hitherto “unknown” tool 4 is then determined/classified as a drilling tool. The further measurement of functional geometries 16 of a “drilling tool” (also just “drill” for short) ensues.

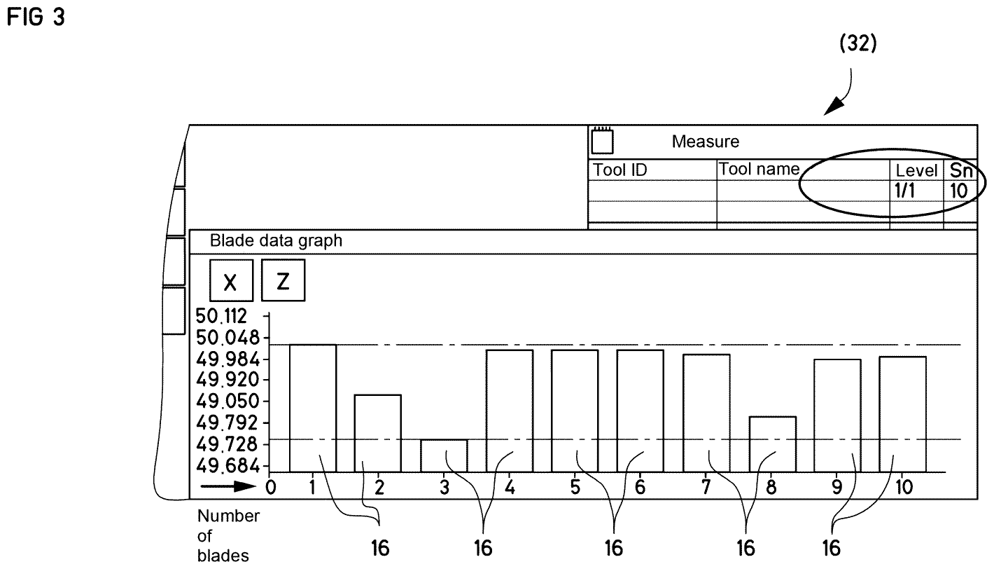

Since, however—in the present case—the “unknown” tool 4 is a (ten-blade) milling tool (cf. FIG. 3), no tip 14 will be found at the tool 4—and this tool 4 will as such also not be categorized/recognized as a drilling tool.

In the case of this “no tip” at the tool 4, a radially outer edge 18 on the tool is then determined. That is to say that the camera apparatus 10 moves radially outward (x-axis)—to the radially outer margin 20 of the tool 4.

The camera apparatus 10 detects the radially outer margin 20—and the spindle 42 begins to turn the tool 4, or complete tool 6, clamped in it (about its longitudinal/central axis or z-axis 46).

While the tool 4 is rotating, the camera apparatus 10 continuously determines the contour 22 of the tool 4 in the respective turning position. The determined contours 22 are evaluated, here using predefined comparison patterns, to the effect of whether a blade 16 (functional geometry 16) of the tool 4 is recognizable in the contour profile (of the respective turning position of the tool 4). If a contour 22 is recognized as a blade 16/functional geometry 16, the blade/functional geometry is also measured.

The tool 4 is completely rotated (360°) at least once about its central, or longitudinal, axis or z-axis 46, and in this way—at the end of the rotation process—all blades 16 (functional geometries 16) (possibly present in the case of a cutting or milling tool) have been recognized—and then also measured in such a case.

Therefore, it is now definite whether (a) the tool 4 is a milling, or cutting, tool—and (b) a cutter with how many blades is present here.

In the present case described here, blades 16 (functional geometries 16)—ten in number—were recognized and measured, where the “unknown” tool was thus now identified and correspondingly classified as a ten-blade milling tool.

FIG. 2 and in the detail therefrom FIG. 3 show the measurement of the (in this case ten) blades 16 (functional geometries 16) of the—in this case—milling tool.

As revealed by FIGS. 2 and 3 (excerpt from the operating interface/touchscreen 38),—in this case—the “x”-dimensions, i.e. the radial dimension, of the ten blades 16 are represented graphically (in bar form (height of the bar corresponding to radial dimension)). By “switching” to the “z”-dimension, the respective “z”-dimensions (z-axis) of the ten blades 16 are then also represented accordingly. In one variant, x- and z-dimensions could also be displayed simultaneously in a superimposed form.

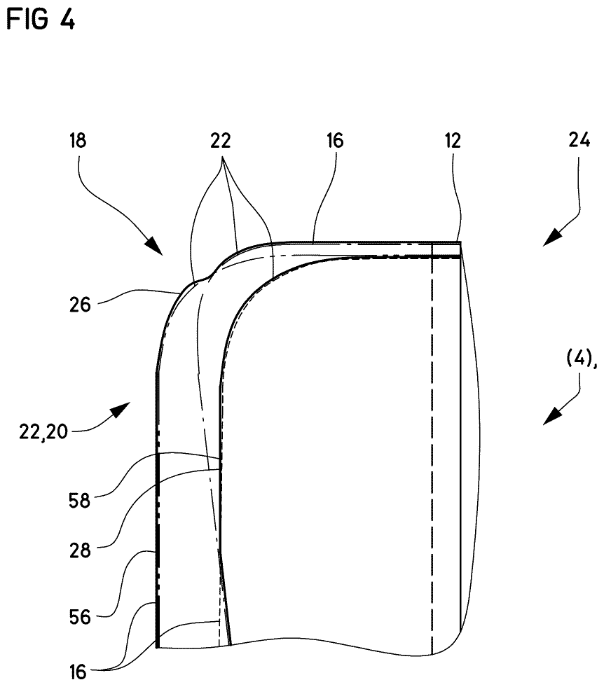

The respective representations make it possible to be able quickly and easily to recognize differences in the blades 16, or the states thereof, e.g. the furthest outer blade 56 (cf. FIG. 4) (FIGS. 2 and 3—blade 1) vs. the furthest inner blade 58 (FIG. 4) (FIGS. 2 and 3—blade 3) (cf. FIG. 2 and FIG. 3, respectively—correspondingly marked by the two straight lines), or the highest blade vs. the lowest blade.

In this respect, FIG. 4 shows a corresponding cumulative image 24, in which—using the measured blades 16—the blade contour profiles thereof are represented in a jointly superimposed manner.

In the cumulative image 24, as shown in FIG. 4, the measured functional geometries/blades 16 of the tool are represented in a superimposed manner (in “x” and “z”), whereby in this way—in the image (also computationally ascertainable)—a maximum outer contour 26 referred to as cumulative geometry 26—here in “x” and “z”—is manifested in the case of the milling tool/tool 4.

Equally, in this way a minimum contour 28—for example likewise from the cumulative image 24—can be inferred or (also computationally) determined, which minimum contour—put simply and clearly (as a counterpart of the cumulative geometry 26)—forms a “minimum inner contour” 28.

From the maximum outer contour 26, or cumulative geometry 26, and the minimum inner contour 28 (in “x”), in this way it is then also possible to ascertain a concentricity, a planarity and a roundness for the tool 4.

Once the blades 16 (functional geometries 16) of the tool 4 have been measured, they are deposited (in a memory, or tool management system) as a reference—and are thus available as a comparison for newly measured blades 16/functional geometries 16 of this tool 4 during a remeasurement of this tool 4.

Pieces of wear information for the tool 4 can be ascertained from such a comparison. From the pieces of wear information, it is then also possible to derive other properties such as e.g. a remaining service life or a remaining travel.

If no individual blade/blades 16 has/have been recognized during the contour recognition (see above), such a tool 4 (also no tip 14—see above) can be assumed to be a grinding disc 4 and its circumferential grinding disc edge 18 (cf. functional geometry 16) is then measured. Here too, the cumulative image 24, the cumulative geometry 26 and the minimum contour 28 can then be ascertained, stored and evaluated (e.g. concentricity, planarity, . . . ).

If a tip 14 was recognized in the case of a tool 4—and the tool was thus classified as a drill 4, then the camera apparatus 10 moves axially to the height at which the tool/the drill 4, or the drilling tip thereof, has its maximum external diameter,—and there radially outward—to the radially outer margin 20 of the tool.

From here the same procedure, as described, as in the case of a milling tool 4 takes place—in the case of a drilling tool 4.

The camera apparatus 10 detects the radially outer margin 20—and the spindle 42 begins to turn the tool/drill 4 clamped in it (about its longitudinal/central or z-axis 46).

While the tool/drill 4 is rotating, the camera apparatus 10 continuously determines the contour 22 of the tool/drill 4 in the respective turning position. The determined contours 22 are evaluated to the effect of whether a blade 16 (functional geometry 16) of the tool 4 is recognizable in the contour profile (of the respective turning position of the tool 4). If a contour 22 is recognized as a blade 16/functional geometry 16, the blade/functional geometry is also measured.

The tool/drill 4 is completely rotated (360°) about its central, or longitudinal, axis or z-axis 46, and in this way—at the end of the rotation process—all blades 16 (functional geometries 16) have been recognized—and then also measured in such a case. The cumulative image 24, the cumulative geometry 26 and the minimum contour 28 and also pieces of wear information are correspondingly ascertained, stored and evaluated.

In the case of the autonomous measurement of a tool described here, the measurement at the tool takes place in “only” one plane (first plane—cf. FIGS. 2 and 3 “Level 1/1”—identified by border marker), namely at the “outer cutting edge” 18 (near the tip 14 of the tool 4).

Such a measurement, as described, can also be carried out at other axial heights (z-axis) (second/third plane and so on) on the tool 4, for example where the diameter of the tool 4 changes (e.g. steps in the case of a “step drill”) and/or where other, or additional, functional geometries 16, for example (further) indexable/cutting inserts (functional geometries 16), are disposed on a tool, and/or at another (any other) height.

Here, the camera apparatus 10 then moves along the outer edge of the tool 4 until—in a further plane—further functional geometries 16 are recognized and where the measurement procedure described (see above) is repeated. Here too, the cumulative image 24, the cumulative geometry 26 and the minimum contour 28 and also pieces of wear information can again be correspondingly ascertained, stored and evaluated.

### Function Program “Digital Twin”

The function program “digital twin” is started in accordance with the function program “Maximum SE” described above, in which case here the generation of the (collision-relevant) digital twin is then started (not shown) autonomously or by the touching of the function button “Digital twin” on the display device 38/monitor 38.
if the tool is not rotating:

During the generation of the collision-relevant digital twin of a complete tool 6—here for a non-rotating tool 4, for example a turning tool 4,—the tool is scanned—and a digital image representation of the complete tool is thereby created.

The scanning takes place—in this case when the tool 4 is not rotating—by using a 2D scan of the complete tool 6—this scan being carried out by the camera apparatus 10—, a contour of the complete tool 6 on both sides being measured—in a predefined fixed position of the complete tool 6 (stationary spindle 42).

In this case, the camera apparatus 10 moves in an automated manner to different heights of the complete tool 6 and at each of these heights makes a recording of the complete tool 6, or of a detail of the complete tool 6, from which recordings the contour, or the contour profile, of the complete tool 6 is then “extracted”, which then forms the (two-dimensional) digital image representation.

This takes place in the form that the camera apparatus 10 is moved step by step firstly from the bottom, i.e. from the lower end of the complete tool 6, to the top, i.e. to the upper end of the complete tool 6, the camera apparatus 10 here being oriented towards the contour of one side of the complete tool 6—and the contour of the one side of the complete tool 6 being ascertainable in this case.

Subsequently, the camera apparatus 10 moves step by step from the top to the bottom, here the camera apparatus 10 being oriented towards the contour of the other side of the complete tool 6—and the contour of the other side of the complete tool 6 being ascertainable in this case.

In addition to the scanning of the complete tool, a first blade point, a blade starting point, and a second blade point, a blade end point, are furthermore then measured at the tool 4, or the complete tool 6, by using the camera apparatus 10.

For this purpose it is possible—if there were a desire for this not to be carried out autonomously—for an operator to move the camera apparatus 10 to the two corresponding heights, each of which the operator can monitor by way of a display on the monitor 38, and to focus the blade starting point and the blade end point, respectively, there—and then to be able to initiate the respective measurement by using the keyboard 40. Otherwise this takes place autonomously.

In the digital image representation, using the measured first and the measured second blade points, or using these ascertained closest points in the digital image representation, a blade region is then ascertained (“collision-relevant digital twin”).
if the tool is rotating:

During the generation of the collision-relevant digital twin of a complete tool 6—here for a rotating tool 4, for example a milling tool 4,—the tool is likewise scanned—and—in this case of a rotating tool 4—a (three-dimensional) digital image representation of the complete tool 6 is created.

The scanning takes place—in this case when the tool 4 is rotating—by using a 3D scan of the complete tool 6—this scan being carried out by the camera apparatus 10—, a contour of the complete tool on one side being measured—when the complete tool 6 is turned in a varying manner (rotating spindle 42).

In this case, the camera apparatus 10 moves in an automated manner to different heights of the complete tool 6—and at each of these heights makes recordings of the complete tool 6, or of a detail of the complete tool 6 in complete tool positions turned in a varying manner (by using the spindle 42), from which recordings the envelope contour of the complete tool 6 is then “extracted”, which then forms the three-dimensional digital image representation.

This takes place in the form that the camera apparatus 10 is moved step by step preferably from the bottom, i.e. from the lower end of the complete tool 6, to the top, i.e. to the upper end of the complete tool 6, the camera apparatus 10 here being oriented towards the contour of one side of the complete tool 6. At each of the heights moved to, different recordings of the complete tool 6 are made—in complete tool positions turned in a varying manner in each case.

In addition to the scanning of the complete tool 6, a first blade point, a blade starting point, and a second blade point, a blade end point, are furthermore then recognized and measured—possibly using AI (Artificial Intelligence)—at the tool 6, or the complete tool 6, by using the camera apparatus 10.

For this purpose it is possible—if there were a desire for this not to be carried out autonomously—for an operator to move the camera apparatus 10 to the two corresponding heights, each of which the operator can monitor by way of a display on the monitor 38, and to focus the blade starting point and the blade end point, respectively, there—and then to be able to initiate the respective measurement by using the keyboard 40. Otherwise this takes place autonomously.

In the digital image representation, using the measured first and the measured second blade points, or using these ascertained closest points in the digital image representation, a blade region is then ascertained (“collision-relevant digital twin”) and identified as such.

Based on these data, the machine tool and/or an external programming station then carries out the collision simulation.

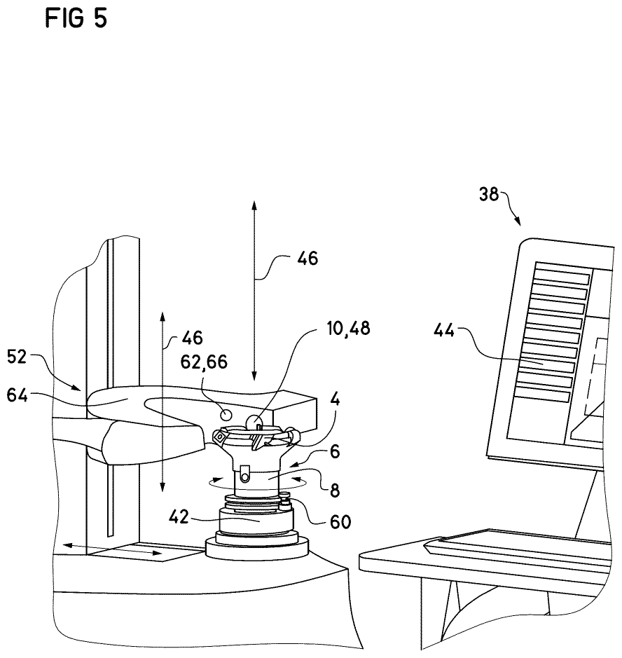

(Measuring Device) Carrier 64 with Reading Device/Reader 62 for Reading a Data Carrier 60 on the Tool Holder 8 (FIG. 5)

FIG. 5 shows—as part of the slide 52 of the presetting instrument 2—a (approximately U-shaped) measuring device carrier 64 in the case of the presetting instrument 2 with a reader/reading device 62 integrated there for reading a data carrier 60 on the tool holder 8.

The complete tool 6 held, or clamped, in the spindle 42—more precisely the tool holder 8—provides a data carrier 60, for example here in the form of a contactlessly readable data carrier, such as an RFID chip, through the use of which the tool holder 8 can be identified fully automatically (also in the context of prescribed autonomous sequences) and further measurement data therefor can be acquired. The position of the data carrier 60 on the tool holder 8 is standardized in this case (HSK/SK tool holder).

In this way, incorrect assignments or missing tools are avoided and maximum tool deployment and high machine availability are ensured. In this case—by using the data carrier 60—all tool-relevant data are or have been stored—here contactlessly—on the data carrier, which is fixedly connected to the tool holder 8 (for example as described in German Application DE 10 2016 102 692 A1, corresponding to U.S. Pat. No. 10,896,363 B2). In addition or else instead of individual tool data, a code/value uniquely identifying the tool, or the like, can also be stored on the chip.

As also shown by FIG. 5, the complete tool 6, or the tool holder 8, is disposed on the spindle 42, which is rotatable automatically about the rotation/central, or longitudinal, axis 46 (z-axis)—in particular also by an actuator that is not shown in more specific detail.

The abovementioned camera apparatus 10 of the presetting instrument 2 (cf. FIG. 1, camera 48 and illumination device 50) is disposed on the U-shaped measuring device carrier 64, which is part of the slide 52 of the presetting instrument 2—and which, as indicated in FIG. 5, is movable along two axes (“x” and “z” 46) manually, and in particular also automatically (cf. autonomous process—see above).

Furthermore, a reader 62—having a read/write head 66 that is movable (in the horizontal plane)—is integrated in the measuring device carrier 64, as indicated in FIG. 5, which reader can read data from the data carrier 60 on the tool holder 8.

Put clearly, the read/write head 66 of the reader 62 moves out of the measuring device carrier 64 directly to the data carrier (in this position the data can be read from the data carrier 60)—and also back again into the measuring device carrier.

Data are read from the data carrier 60 either in a manner integrated autonomously in the process—or as a separate autonomous process by using a function button 44 on the touchscreen 38 (here, touching the function button 44 then starts the autonomous reading process).

The measuring device carrier 64 moves—along the central axis/z-axis 46—autonomously into a basic position, the axial height of which corresponds to the axial height at which the data carrier 60 is secured to the tool holder 8.

The complete tool 6, or the tool holder 8, is rotated—by using the spindle 42—autonomously about the z-axis—until the data chip 60 disposed in a standardized position on the tool holder 8 ends up in front of the reader 62. In this case, the—adapter-dependent—angle value of the chip position is known in the system but can optionally be searched for with camera assistance.

A read/write head 66 of the reader 62 moves directly up to the data carrier 60—and reads the data thereof. Afterwards, the read/write head 66 moves back again.

If the positioning of the reading device 62 in front of the data carrier 60 is intended to be effected (totally) without prior knowledge (cf. standardized position), then there can be provision for, using Artificial Intelligence-based image processing, the camera unit 10 to “search for” the data carrier 60 on the tool holder 8 and thus recognize, or determine, the position of the data carrier. Height positioning of the measuring device carrier 64 and spindle rotation and then the reading can then take place accordingly.

Such a reader 62 in the measuring device carrier 64 of a presetting instrument 2 can also be used in a corresponding (also functional) manner for any other machine tool.

Moreover, the read/write head 66 could also simply be a specific camera that is mounted on the measuring device carrier 64 and identifies the tool holder 8—or else a reader 62 that reads a marking, for example a QR code, on the tool holder 8. Such a marking can then identify the tool holder 8 or else include tool data in encoded form.

This additional aspect described here in association with FIG. 5 in the case of a presetting instrument 2 (“(measuring device) carrier 52 with reading device/reader 62 for reading a data carrier 60 on the tool holder 8 (FIG. 5)”) can also be pursued further as a separate subject matter of a divisional application—also independently of the presetting instrument, or independently in relation to a presetting instrument.

Although the invention has been illustrated and described in more detail by the preferred exemplary embodiments, the invention is not restricted by the examples disclosed and other variations can be derived therefrom, without departing from the scope of protection of the invention.

The following is a summary list of reference numerals and the corresponding structure used in the above description of the invention:
2 apparatus for measuring a tool or a complete tool, presetting instrument
4 (rotating/non-rotating) tool, milling tool, grinding disc, drilling tool/drill
6 complete tool
8 tool holder, (hydro-expansion) clamping chuck
10 measuring unit, (optical) measuring device, camera unit
12 (topmost/highest) point
14 tip, drilling tip
16 functional geometry
18 radially outer edge, cutting edge, grinding disc edge
20 radially outer edge
22 contour
24 cumulative image
26 cumulative geometry, maximum outer contour
28 minimum contour, minimum inner contour
32 operating and display interface
34 computing and control unit
36 interface with the machine tool
38 display device, monitor, touchscreen
40 input device, keyboard
42 spindle
44 function button
46 central/longitudinal/rotation axis, z-axis
48 camera
50 illumination device
52 slide
54 printer
56 furthest outer blade 16
58 furthest inner blade 16
60 data carrier, RFID chip
62 reading device/reader (for 60)
64 measuring device carrier (as part of the slide 52)
66 read/write head (of 62)

1. A method for autonomously measuring a tool or a complete tool including a tool holder and a tool clamped in the tool holder, the method comprising:
initially autonomously determining a type of the tool;
then autonomously determining a point on the tool distinguishing the tool according to the type of the tool;
autonomously measuring functional geometries of the tool starting from the point; and
subsequently autonomously ascertaining a cumulative geometry for the tool from the measured functional geometries.

2. The method for autonomously measuring a tool or a complete tool according to claim 1, which further comprises at least one of selecting the determined type of the tool or complete tool as a milling tool with or without indexable inserts, a drilling tool, a turning tool with or without cutting inserts, or at least one of a grinding disc, or selecting the functional geometries as geometries of a blade of a machining tool.

3. The method for autonomously measuring a tool or a complete tool according to claim 1, which further comprises using Artificial Intelligence-based image processing to determine the type of the tool.

4. The method for autonomously measuring a tool or a complete tool according to claim 1, which further comprises selecting the point as a topmost point of a drilling tool or a point on an outer edge of a milling tool or a grinding disc.

5. The method for autonomously measuring a tool or a complete tool according to claim 1, which further comprises at least one of:
determining a highest point of the tool or complete tool on a central or longitudinal axis of the tool or a z-axis of the complete tool, or
using the highest point to carry out a check to establish whether a tip is present on the tool or complete tool, or
when a tip is present, selecting the determined type of the tool or complete tool as a drilling tool, or
when no tip is present, determining a radially outer edge on the tool or complete tool, and using the radially outer edge to determine blades on the tool or complete tool using predefined comparison patterns, or
measuring the blades.

6. The method for autonomously measuring a tool or a complete tool according to claim 1, which further comprises turning or rotating the tool or the complete tool during measurement, the functional geometry being autonomously recognized during turning, or rotating and being measured, and repeatedly carrying out turning or rotating, recognition and measurement at least until the tool or the complete tool has completed a full revolution about its central longitudinal axis and finally all functional geometries have been recognized and all functional geometries have been measured.

7. The method for autonomously measuring a tool or a complete tool according to claim 6, which further comprises turning or rotating the tool or the complete tool about the central longitudinal axis during measurement while clamped in a spindle, and the functional geometry being a blade geometry.

8. The method for autonomously measuring a tool or a complete tool according to claim 6, which further comprises at least one of depositing or storing the measured functional geometry or geometries of the tool or complete tool as a reference, with a remeasurement of the tool or the complete tool involving newly measured functional geometry or geometries being compared with the reference as an image comparison using Al-based image processing, allowing at least one of wear on a functional geometry or a defective functional geometry to be ascertained.

9. The method for autonomously measuring a tool or a complete tool according to claim 6, which further comprises ascertaining a cumulative image from a superimposition of the measured functional geometries of a tool or complete tool, the cumulative image containing an image of a maximum outer contour for the tool or complete tool.

10. The method for autonomously measuring a tool or a complete tool according to claim 9, which further comprises using the cumulative geometry of the tool or the complete tool together with at least one of a minimum contour of the tool or complete tool or a concentricity or a planarity or a roundness being ascertained for the tool or complete tool.

11. The method for autonomously measuring a tool or a complete tool according to claim 1, which further comprises scanning the tool or the complete tool with at least one of a 2D scan or a 3D scan, resulting in at least one of a digital twin or a collision-relevant, or machining-relevant, digital twin of the tool or the complete tool being ascertained.

12. The method for autonomously measuring a tool or a complete tool according to claim 11, which further comprises comparing the measurement and the collision-relevant or machining-relevant digital twin to a predefinable tool height or complete tool height or to different predefinable tool heights or complete tool heights.

13. The method for autonomously measuring a tool or a complete tool according to claim 1, which further comprises connecting measured surface points on the tool or the complete tool by using Al-based image processing to form a contour of the tool or complete tool.

14. The method for autonomously measuring a tool or a complete tool according to claim 1, which further comprises carrying out the method on at least one of a rotary tool or a machining tool or a cutting or milling tool or a cutting or milling tool clamped in a tool holder or a drilling tool or a drilling tool clamped in a tool holder or a grinding disc or a grinding disc clamped in a tool holder.

15. An apparatus for autonomously measuring a tool or a complete tool including a tool holder and a tool clamped in the tool holder, the apparatus comprising:
a measuring unit and a computing and control unit configured to:
initially autonomously determine a type of the tool;
then autonomously determine a point on the tool distinguishing the tool according to the type of the tool;
autonomously measuring functional geometries of the tool starting from the point; and
subsequently autonomously ascertaining a cumulative geometry for the tool from the measured functional geometries.

16. The apparatus for autonomously measuring a tool or a complete tool according to claim 15, wherein said measuring unit and said computing and control unit are configured to carry out a method for autonomously measuring the tool or the complete tool.

17. The apparatus for autonomously measuring a tool or a complete tool according to claim 15, wherein said measuring unit has one or more optical and/or non-contact-measurement measuring apparatuses.

18. The apparatus for autonomously measuring a tool or a complete tool according to claim 17, wherein said one or more optical and/or non-contact-measurement measuring apparatuses include at least one of a digital camera or a radar or a lidar or a measuring apparatus operating according to a transmitted or reflected light method or an image sensor or a digital image sensor.

19. The apparatus for autonomously measuring a tool or a complete tool according to claim 17, wherein said one or more optical and/or non-contact-measurement measuring apparatuses include a plurality of measuring apparatuses, the tool or the complete tool measuring from different perspectives or axes, thereby allowing positions of functional geometries or blades to be determined.

20. The apparatus for autonomously measuring a tool or a complete tool according to claim 17, wherein said one or more optical and/or non-contact-measurement measuring apparatuses has a type selected according to a requirement for measurement accuracy.

21. The apparatus for autonomously measuring a tool or a complete tool according to claim 15, which further comprises a measuring device carrier, and a reader for reading data of a data carrier disposed on the tool holder at said measuring device carrier.

22. A processing center, comprising:
the apparatus for autonomously measuring a tool or a complete tool according to claim 15, and a machine tool.

23. The processing center according to claim 22, which further comprises a common base, the apparatus and said machine tool being mounted on said common base.

24. The processing center according to claim 22, wherein said apparatus is integrated in said machine tool.

25. A method for autonomously measuring a tool or a complete tool, the method comprising measuring the tool or the complete tool by using the apparatus for autonomously measuring a tool or a complete tool according to claim 15.

26. A method for autonomously measuring a tool or a complete tool, the method comprising scanning the tool or the complete tool with at least one of a 2D scan or a 3D scan by using the apparatus for autonomously measuring a tool or complete tool according to claim 15, resulting in at least one of a digital twin or a collision-relevant, or machining-relevant, digital twin of the tool or the complete tool being ascertained.
